(19) United States
(12) Patent Application Publication
(10) Pub. No.: US 2026/0023155 A1
(43) Pub. Date: Jan. 22, 2026

(54) RADAR DEVICE AND SHORT-RANGE LEAKAGE CANCELLATION METHOD THEREOF

(71) Applicant: Realtek Semiconductor Corporation, Hsinchu (TW)

(72) Inventors: Jhih Yong TANG, Hsinchu (TW); Chang-Ming LEE, Hsinchu (TW); Shau-Yu CHENG, Hsinchu (TW); Der-Zheng LIU, Hsinchu (TW); ChiFang CHANG, Hsinchu (TW); Wen-Yung LEE, Hsinchu (TW)

(21) Appl. No.: 19/275,974

(22) Filed: Jul. 21, 2025

Related U.S. Application Data
(60) Provisional application No. 63/673,798, filed on Jul. 22, 2024.

(30) Foreign Application Priority Data
Jul. 9, 2025 (TW) 114126055

(51) Int. Cl. G01S 7/35; G01S 7/02

(52) U.S. Cl. CPC G01S 7/354; G01S 7/023; G01S 7/356

(57) ABSTRACT

A radar device includes a frequency modulated continuous wave (FMCW) generator, a radio frequency (RF) circuit, a computing circuit, and a coherent subtractor. The FMCW generator is configured to generate an FMCW signal. The RF circuit is configured to modulate the FMCW signal into an RF signal and demodulate a reflection signal reflected at a target from the RF signal, so as to obtain a received signal. The computing circuit is configured to reconstruct a short-range leakage signal according to the FMCW signal and an estimated channel coefficient, a delay coefficient, a phase coefficient, and an amplitude coefficient obtained in a short-range leakage estimation stage of the radar device. The coherent subtractor is configured to compensate the received signal by the reconstructed short-range leakage signal.

### RELATED APPLICATIONS

This application claims priority to U.S. Provisional Application Ser. No. 63/673,798, filed Jul. 22, 2024, and Taiwan Application Serial Number 114126055, filed Jul. 9, 2025, which are herein incorporated by reference.

### BACKGROUND

### Technical Field

The present disclosure relates to radar technology, and more particularly to a radar device and a short-range leakage cancellation method thereof.

### Description of Related Art

The radar technology uses emission of electromagnetic waves and reception of their reflected waves to detect a target and determine its position, direction of movement, and/or moving speed. On the other hand, the technologies or applications of detecting surrounding environments by using Wi-Fi signals have been present nowadays, which can be implemented in the devices that support the Wi-Fi technologies and detect nearby objects or even vital signs by analyzing changes in the Wi-Fi signals. However, with the miniaturization of devices, the distance between the antennas inside a device is reduced, and thus the receiver antenna will directly receive the electromagnetic waves emitted by the transmitter antenna, which causes a short-range leakage and in turn severely affects the detection sensitivity.

### SUMMARY

The present disclosures provides a radar device which includes a frequency modulated continuous wave (FMCW) generator, a radio frequency (RF) circuit, a computing circuit, and a coherent subtractor. The FMCW generator is configured to generate an FMCW signal. The RF circuit is configured to modulate the FMCW signal into an RF signal and demodulate a reflection signal reflected at a target from the RF signal to obtain a received signal. The computing circuit is configured to reconstruct a short-range leakage signal according to the FMCW signal and an estimated channel coefficient, a delay coefficient, a phase coefficient, and an amplitude coefficient obtained in a short-range leakage estimation stage of the radar device. The coherent subtractor is configured to compensate the received signal by the short-range leakage signal.

The present disclosures further provides a short-range leakage cancellation method which is performed by a radar device and includes: generating an FMCW signal; modulating the FMCW signal into an RF signal; demodulating a reflection signal reflected at a target from the RF signal to obtain a received signal; reconstruct a short-range leakage signal according to the FMCW signal and an estimated channel coefficient, a delay coefficient, a phase coefficient, and an amplitude coefficient obtained in a short-range leakage estimation stage of the radar device; and compensating the received signal by the short-range leakage signal.

### BRIEF DESCRIPTION OF THE DRAWINGS

The foregoing aspects and many of the accompanying advantages of this disclosure will become more readily appreciated as the same becomes better understood by reference to the following detailed description, when taken in conjunction with the accompanying drawings.

FIG. 1 is a schematic diagram of a radar device in accordance with some embodiments of the present disclosure.

FIG. 2 is an equivalent block diagram of the radar device in FIG. 1 performing a target detection.

FIG. 3 is a schematic flowchart of the operations performed by the radar device in FIG. 1 at a short-range leakage estimation stage.

FIG. 4 is an example of a training sequence generated by the FMCW generator of the radar device in FIG. 1.

### DETAILED DESCRIPTION

The detailed explanation of the disclosure is described as following. The described preferred embodiments are presented for purposes of illustrations and description, and they are not intended to limit the scope of the disclosure.

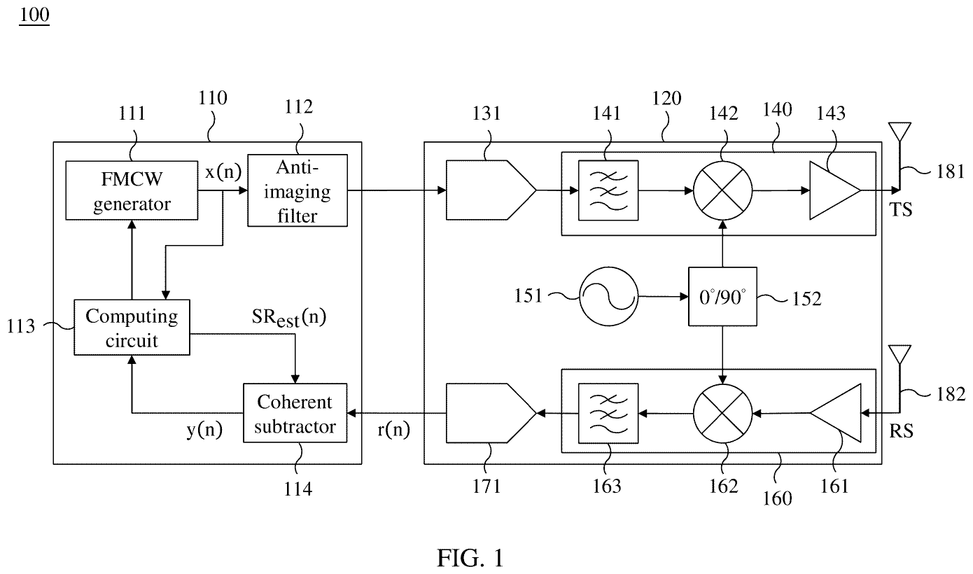

FIG. 1 is a schematic diagram of a radar device 100 in accordance with some embodiments of the present disclosure. The radar device 100 includes a baseband processor 110, an RF circuit 120, a transmitter antenna 181, and a receiver antenna 182. The baseband processor 110 includes an FMCW generator 111, an anti-imaging filter 112, a computing circuit 113, and a coherent subtractor 114. The RF circuit 120 includes a digital-to-analog converter (DAC) 131, RF front-ends 140 and 160, a local oscillator 151, an in-phase/quadrature carrier signals generator 152, and an analog-to-digital converter (ADC) 171. The following describes the target detection flow of the radar device 100 in a signal transmission period and a signal reception period.

During the signal transmission period, in the baseband processor 110, the FMCW generator 111 generates an FMCW signal x(n) first, and then the anti-imaging filter 112 performs an upsampling and a discrete finite impulse response (DFIR) filtering on the FMCW signal x(n). The FMCW signal x(n) may have a linear modulated frequency, e.g., a chirp signal. After the processes of the baseband processor 110, in the RF circuit 120, the DAC 131 converts the FMCW signal x(n) from a digital form to an analog form first, and then the RF front-end 140 modulates the FMCW signal x(n) to generate an RF signal TS, and transmits the RF signal TS in a radio wave form via the transmitter antenna 181. The RF front-end 140 includes an analog low-pass filter (ALPF) 141, a mixer 142, and a power amplifier 143, in which the ALPF 141 is configured to perform a low-pass filtering on the FMCW signal x(n) in an analog form to filter out the high-frequency component of the FMCW signal x(n), the mixer 142 is configured to perform a frequency up-modulation on the FMCW signal x(n) to generate the RF signal TS, and the power amplifier 143 is configured to enhance the transmission power of the RF signal TS. The local oscillator 151 is configured to generate a carrier signal, and the in-phase/quadrature carrier signals generator 152 is configured to performing a phase shifting on the carrier signal, so as to generate an in-phase carrier signal (the phase thereof is 0°) and a quadrature carrier signal (the phase thereof is 90°), such that the RF signal TS includes an in-phase component and a quadrature component. If the radar device 100 supports the Wi-Fi technologies, the bandwidth of the RF signal TS may be in a Wi-Fi frequency band (e.g., the 2.4 GHz frequency band).

Then in the signal reception period, the receiver antenna 182 receives a reflection signal RS (which is the signal reflected at a target from the RF signal TS) first, and the RF front-end 160 demodulates the reflection signal RS to obtain a demodulated signal, and then the ADC 171 converts the demodulated reflection signal into a received signal r(n) of a digital form. The RF front-end 160 includes a low-noise amplifier (LNA) 161, a mixer 162, and an ALPF 163, in which the LNA 161 is configured to enhance the signal-to-noise ratio (SNR) of the reflection signal RS, the mixer 162 is configured to perform a frequency down-demodulation on the reflection signal RS based on the in-phase carrier signal and the quadrature carrier signal, and the ALPF 163 is configured to perform a low-pass filtering on the frequency-down reflection signal RS to filter out the high-frequency component thereof.

For the structure shown in FIG. 1, the received signal r(n) may be expressed by Formula (1) as follows:

$$r ( n ) = [ ( x ( n ) * {h}_{A F} ( n ) * {h}_{T X} ( n ) * {h}_{L} ( n ) + {d}_{L} + w ( n ) ) {e}^{j θ} ] * {h}_{R X} ( n ) + {d}_{adc} , \qquad ( 1 )$$

where * represents convolution, h_{AF}(n) is the impulse response of the anti-imaging filter 112, h_{TX}(n) is the impulse response of the ALPF 141, h_{L}(n) is the impulse response of the short-range leakage path, d_{L} is the direct current (DC) offset of the local oscillator leakage, w(n) is additive white Gaussian noise (AWGN), θ is an initial phase, h_{RX}(n) is the impulse response of the ALPF 163, and d_{adc} is the DC offset of the ADC 171. After excluding the factors of DC offset, noise, and phase offset, the effective channel response h(n) may be expressed by Formula (2) as follows:

$$h ( n ) = {h}_{A F} ( n ) * {h}_{T X} ( n ) * {h}_{L} ( n ) * {h}_{R X} ( n ) . \qquad ( 2 )$$

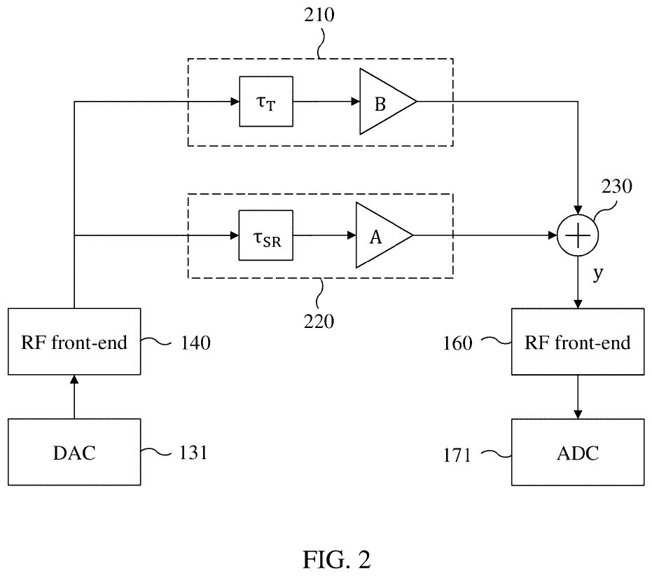

FIG. 2 is an equivalent block diagram of the radar device 100 performing a target detection. In the schematic diagram of FIG. 2, the signal path is separated into two paths, one of which is a target reflection path 210, and the other of which is a short-range leakage path 220. The target reflection path 210 has a target delay T_{T} and a target gain B. The short-range leakage path 220 has a short-range leakage delay T_{SR} and short-range leakage gain A. After a superimposition 230 of the signals respectively through the target reflection path 210 and the short-range leakage path 220, the superimposed signal y is A×y_{SR}+B×y_{T}, where y_{SR} and y_{T} are the signals respectively in the short-range leakage path and the target reflection path and are respectively associated with T_{SR} and T_{T}, T_{T}=T_{SR}+Tᵣ, and Tᵣ the delay generated by reflection. However, because the short-range leakage gain A is usually much greater than the target gain B, if the effect on the short-range leakage gain A cannot be effectively eliminated, the target to be detected will be buried in the frequency domain, resulting in failure of target detection.

The radar device 100 may perform a short-range leakage estimation and a short-range leakage cancellation to solve the problems described above. The computing circuit 113 may calculate an estimated channel coefficient

$${h}_{srk}^{est}$$

according to Formula (2) at the short-range leakage estimation stage, and may obtain a delay coefficient

$${T}_{srk}^{est} ,$$

a phase coefficient

$${θ}_{srk}^{est} ,$$

and an amplitude coefficient aₛᵣₖ^{est}. Then, at the short-range leakage cancellation stage, by utilizing the delay coefficient

$${T}_{srk}^{est} ,$$

the phase coefficient

$${θ}_{srk}^{est} ,$$

and the amplitude coefficient

$${a}_{srk}^{est} ,$$

to compensate the mismatches of the coefficients such as delay, phase, and amplitude between the short-range leakage cancellation stage and the short-range leakage estimation stage (which are caused possibly by, e.g., temperature drift and/or other environmental factors) and reconstruct a short-range leakage signal SRₑₛₜ(n). As such, the short-range leakage component of the received signal r(n) can be cancelled.

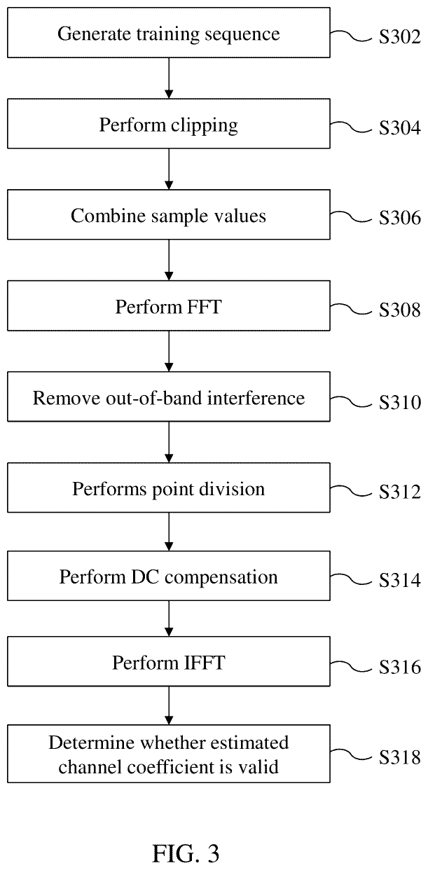

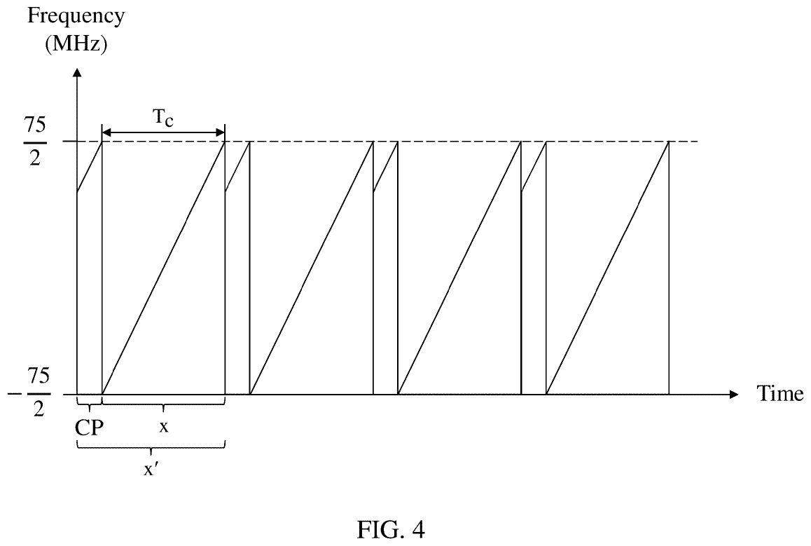

FIG. 3 is a schematic flowchart of the operations performed by the radar device 100 at the short-range leakage estimation stage. At Operation S302, the FMCW generator 111 generates a training sequence x′. The training sequence x′ includes a chirp symbol x and a cyclic prefix sequence CP, in which the cyclic prefix sequence CP is in front of the chirp symbol x and is obtained by copying the last L sample values of the chirp symbol x, and the frequency of the chirp symbol x linearly rises from −75/2 MHZ to 75/2 MHz. The number of the training sequences x′ used by the radar device 100 may be 3 or more. In the example of FIG. 4, there are 4 training sequences x′ adjacent to each other front and back, and in a condition in which the clock frequency is 320 MHz and the bandwidth is 150 MHZ, the duration T_{c} of each chirp symbol x may be 3.2 microseconds, and the number of samples N (N>L) of each chirp symbol x may be 1024. The training sequence x′ is transmitted through the processing of the subsequent elements. In the subsequent operation, the computing circuit 113 performs a signal processing on the training signal corresponding to the training sequence x′, thereby obtaining an estimated channel coefficient

$${h}_{srk}^{e s t} .$$

At Operation S304, the computing circuit 113 clips the training signal to obtain a sequence signal y. The received signal has (N+2L−1) sample values, and the sequence signal y can be obtained by removing the first L and the last L−1 sample values of the received signal. The relationship between the sequence signal y and the training sequence x′ is yₙ=x′*h+wₙ, where yₙ is the n^{th} sample value of the sequence signal y, wₙ is the n^{th} value of the AWGN, n is an integer from 1 to N, and h is the channel coefficient. The sample values of the sequence signal y may be written into a buffer for usage at subsequent operations.

Afterwards, at Operation S306, the computing circuit 113 combines various sample values of the sequence signal y to obtain a received symbol

$${y}_{src}^{c p} = ( {y}_{1} + {y}_{2} + … + {y}_{N} ) / N .$$

Then, at Operation S308, the computing circuit 113 performs a fast Fourier transform (FFT) on the received symbol

$${y}_{src}^{c p} ,$$

so as to convert the received symbol

$${y}_{src}^{c p}$$

to a frequency-domain received symbol

$${Y}_{src}^{c p} , i . e . , {Y}_{src}^{c p} = F F T ( {y}_{src}^{c p} ) .$$

Afterwards, at Operation S310, the computing circuit 113 removes the out-of-band component of the frequency-domain received symbol

$${Y}_{src}^{cp} .$$

For example, in a condition in which the signal bandwidth is 150 MHz, only the component of the frequency-domain received symbol

$${Y}_{src}^{cp}$$

between −75 MHZ and 75 MHz is retained, while the components of the frequency-domain received symbol

$${Y}_{src}^{c p}$$

respectively lower than −75 MHz and higher than 75 MHz are removed (such that the amplitudes of the components of the frequency-domain received symbol

$${Y}_{src}^{c p}$$

respectively lower than −75 MHz and higher than 75 MHz are all 0).

Then, at Operation S312, the computing circuit 113 performs a point division on the frequency-domain received symbol

$${Y}_{src}^{c p}$$

and a frequency-domain chirp symbol X to obtain a frequency-domain estimated channel coefficient

$${h}_{srk}^{c p} .$$

The frequency-domain chirp symbol X may be obtained by performing an FFT on the chirp symbol x by the computing circuit 113, i.e., X=FFT(x), and may be stored in the memory of the baseband processor 110. The relationship between the frequency-domain estimated channel coefficient

$${h}_{srk}^{c p} ,$$

the frequency-domain received symbol

$${Y}_{src}^{cp} ,$$

and the frequency-domain chirp symbol X is

$${H}_{srk}^{c p} [ n ] = {Y}_{src}^{c p} [ n ] / X [ n ] .$$

Afterwards, at Operation S314, the computing circuit 113 performs a DC compensation on the frequency-domain estimated channel coefficient

$${h}_{srk}^{c p} .$$

$${H}_{srk}^{cp} [ 0 ]$$

may be significantly greater than the other sample values of the frequency-domain estimated channel coefficient

$${h}_{srk}^{cp} ,$$

and therefore

$${H}_{srk}^{cp} [ 0 ]$$

can be substituted with the average value of

$${H}_{srk}^{c p} [ - 1 ] and {H}_{srk}^{cp} [ 1 ] , i . e . , {H}_{srk}^{cp} [ 0 ] = ( {H}_{srk}^{cp} [ - 1 ] + {H}_{srk}^{cp} [ 1 ] ) / 2 ,$$

so as to mitigate the negative effect on the estimated channel coefficient hₛᵣₖ^{est} obtained in subsequence.

Then, at Operation S316, the computing circuit 113 performs an inverse fast Fourier transform (IFFT) on the frequency-domain estimated channel coefficient

$${H}_{srk}^{cp} ,$$

so as to transform the frequency-domain estimated channel coefficient

$${H}_{srk}^{cp}$$

into the estimated channel coefficient

$${h}_{srk}^{est} , i . e . , {h}_{srk}^{est} = IFFI ( {H}_{srk}^{cp} ) .$$

In the end, at Operation S318, the computing circuit 113 determines whether the estimated channel coefficient

$${h}_{srk}^{est}$$

is valid (not ruined). The estimated channel coefficient

$${h}_{srk}^{est}$$

will be used in the subsequent short-range leakage cancellation if it is determined to be valid. The condition for determining whether the estimated channel coefficient

$${h}_{srk}^{est}$$

is valid is shown in Formula (3):

$$\frac{{\sum }_{n = N + 1}^{N + M} ABS {( {h}_{srk}^{est} [ n ] )}^{2}}{{\sum }_{n = 1}^{N + M} ABS {( {h}_{srk}^{est} [ n ] )}^{2}} > {h}_{t h} , \qquad ( 3 )$$

where ABS( ) represents the absolute value operation, and hₜₕ is a channel coefficient threshold. In the ideal condition, the (N+1)^{th}-order estimated channel coefficient

$${h}_{srk}^{est} [ N + 1 ]$$

to the (N+M)^{th}-order estimated channel coefficient

$${h}_{srk}^{est} [ N + M ]$$

are an 0. However, the estimated channel coefficients vary in a scenario with, for example, a quantitation error or noise. The excessive estimated channel coefficients

$${h}_{srk}^{est} [ N + 1 ] - {h}_{srk}^{est} [ N + M ]$$

represent that the estimated channel coefficient

$${h}_{srk}^{est}$$

is significantly ruined and cannot be used for short-range leakage cancellation.

After various operations at the short-range leakage stage complete and the valid estimated channel coefficient

$${h}_{srk}^{e s t}$$

is obtained, various operations at the short-range leakage cancellation stage are then performed. In specific, the delay difference

$${T}_{diff}^{e s t} ,$$

the phase difference

$${θ}_{diff}^{e s t} ,$$

and the amplitude difference

$${a}_{diff}^{e s t}$$

between the short-range leakage cancellation stage and the short-range leakage estimation stage are respectively shown in Formulas (4)-(6):

$${T}_{diff}^{e s t} = {T}_{src}^{e s t} - {T}_{srk}^{e s t} , \qquad ( 4 )$$

$${θ}_{diff}^{e s t} = {θ}_{src}^{e s t} - {θ}_{srk}^{e s t} , \qquad ( 5 )$$

$$and$$

$${a}_{diff}^{e s t} = {a}_{src}^{e s t} / {a}_{srk}^{e s t} , \qquad ( 6 )$$

where

$${T}_{src}^{e s t} , {θ}_{src}^{est} , and {a}_{src}^{e s t}$$

are the delay coefficient, the phase coefficient, and the amplitude coefficient at the short-range leakage stage, respectively. The computing circuit 113 provides the delay difference

$${T}_{diff}^{e s t}$$

to the FMCW generator 111, such that the FMCW generator 111 generates the FMCW signal x(n) based on the delay coefficient

$${T}_{diff}^{e s t} .$$

The generated FMCW signal x(n) is

$${e}^{j {πμ ( n - {t}_{diff}^{est} - \frac{{T}_{c}}{2} )}^{2}} ,$$

where μ is the linear frequency modulation (LFM) coefficient, n is an integer from 0 to T_{c}/Tₛ, and Tₛ is the sampling period of the FMCW signal x(n). In addition, the computing circuit 113 calculates the estimated channel coefficient

$${h}_{srk}^{e s t} ,$$

the phase difference

$${θ}_{diff}^{e s t} ,$$

and the amplitude difference

$${a}_{diff}^{e s t}$$

to obtain a short-range leakage cancellation channel coefficient

$${h}_{src}^{e s t} = {h}_{srk}^{e s t} \cdot {e}^{j {θ}_{diff}^{e s t}} \cdot {a}_{diff}^{e s t} ,$$

and performs a convolution on the FMCW signal x(n) and the short-range leakage cancellation channel coefficient

$${h}_{src}^{e s t}$$

to reconstruct the short-range leakage

$$signal {SR}_{e s t} ( n ) = {e}^{j {πμ ( n - {t}_{diff}^{est} - \frac{fmcw \_ t}{2} )}^{2}} ⋆ {h}_{src}^{est} .$$

Then, the reconstructed short-range leakage signal SRₑₛₜ(n) is provided to the coherent subtractor 114. The coherent subtractor 114 compensates the received signal r(n) by the reconstructed short-range leakage signal SRₑₛₜ(n), i.e., performs a coherent subtraction on the received signal r(n) and the short-range leakage signal SRₑₛₜ(n), such that the received signal y(n) received after the compensation is the received signal r(n) subtracted by the short-range leakage component thereof (y(n)=r(n)−SRₑₛₜ(n)).

Summarizing the above description, the present disclosure provides a radar device which includes an FMCW generator, an RF circuit, a computing circuit, and a coherent subtractor. The FMCW generator is configured to generate an FMCW signal. The RF circuit is configured to modulate the FMCW signal into an RF signal and demodulate a reflection signal reflected at a target from the RF signal to obtain a received signal. The computing circuit is configured to reconstruct a short-range leakage signal according to the FMCW signal and an estimated channel coefficient, a delay coefficient, a phase coefficient, and an amplitude coefficient obtained in a short-range leakage estimation stage of the radar device. The coherent subtractor is configured to compensate the received signal by the short-range leakage signal. In some embodiments, the FMCW generator is further configured to generate a training sequence at the short-range leakage estimation stage, and wherein the computing circuit is further configured to perform a signal processing on a received training signal corresponding to the training sequence to obtain the estimated channel coefficient. In some embodiments, the signal processing performed by the computing circuit further includes the following operations: clipping the received training signal to obtain a sequence signal; combining a plurality of sample values of the sequence signal to obtain a received symbol; performing an FFT on the received symbol to transform the received symbol into a frequency-domain received symbol; removing an out-of-band component of the frequency-domain received symbol; performing a point division on the frequency-domain received symbol and a frequency-domain chirp symbol to obtain a frequency-domain estimated channel coefficient; and performing an inverse fast Fourier transform (IFFT) on the frequency-domain estimated channel coefficient, so as to transform the frequency-domain estimated channel coefficient into the estimated channel coefficient. In some embodiments, the signal processing performed by the computing circuit further includes performing a DC compensation on the frequency-domain estimated channel coefficient. In some embodiments, the signal processing performed by the computing circuit further includes determining whether the estimated channel coefficient is valid based on a channel coefficient threshold. In some embodiments, the training sequence includes a chirp symbol and a cyclic prefix sequence prior to the chirp symbol, and wherein the cyclic prefix sequence is obtained by replicating a last plurality of sample values of the chirp signal. In some embodiments, the short-range leakage signal is reconstructed by the computing circuit that performs the following operations: calculating a delay difference, a phase difference, and an amplitude difference between a short-range leakage cancellation stage and the short-range leakage estimation stage corresponding to generation of the FMCW signal based on the delay coefficient, the phase coefficient, and the amplitude coefficient; providing the delay difference to the FMCW generator for generating the FMCW signal accordingly; computing the estimated channel coefficient, the phase difference, and the amplitude difference to obtain a short-range leakage cancellation channel coefficient; and performing a convolution on the FMCW signal and the short-range leakage cancellation channel coefficient to reconstruct the short-range leakage signal. In some embodiments, the radar device further includes an anti-imaging filter that is configured to perform an upsampling and a DFIR filtering on the FMCW signal. In some embodiments, the FMCW signal is a chirp signal with a linear modulation frequency. In some embodiments, a bandwidth of the RF signal is in a Wi-Fi frequency band.

Summarizing the above description, the present disclosure further provides a short-range leakage cancellation method that is performed by a radar device and includes: generating an FMCW signal; modulating the FMCW signal into an RF signal; demodulating a reflection signal reflected at a target from the RF signal to obtain a received signal; reconstruct a short-range leakage signal according to the FMCW signal and an estimated channel coefficient, a delay coefficient, a phase coefficient, and an amplitude coefficient obtained in a short-range leakage estimation stage of the radar device; and compensating the received signal by the short-range leakage signal. In some embodiments, the short-range leakage cancellation method further includes: generating a training sequence at the short-range leakage estimation stage; and performing a signal processing on a received training signal corresponding to the training sequence to obtain the estimated channel coefficient. In some embodiments, the signal processing comprises the following operations: clipping the received training signal to obtain a sequence signal; combining a plurality of sample values of the sequence signal to obtain a received symbol; performing an FFT on the received symbol to transform the received symbol into a frequency-domain received symbol; removing an out-of-band component of the frequency-domain received symbol; performing a point division on the frequency-domain received symbol and a frequency-domain chirp symbol to obtain a frequency-domain estimated channel coefficient; and performing an IFFT on the frequency-domain estimated channel coefficient, so as to transform the frequency-domain estimated channel coefficient into the estimated channel coefficient. In some embodiments, the signal processing further comprises performing a DC compensation on the frequency-domain estimated channel coefficient. In some embodiments, the signal processing further comprises determining whether the estimated channel coefficient is valid based on a channel coefficient threshold. In some embodiments, the training sequence comprises a chirp symbol and a cyclic prefix sequence prior to the chirp symbol, and wherein the cyclic prefix sequence is obtained by replicating a last plurality of sample values of the chirp signal. In some embodiments, the short-range leakage signal is reconstructed by the following operations: calculating a delay difference, a phase difference, and an amplitude difference between a short-range leakage cancellation stage and the short-range leakage estimation stage corresponding to generation of the FMCW signal based on the delay coefficient, the phase coefficient, and the amplitude coefficient; generating the FMCW signal according to the delay difference; computing the estimated channel coefficient, the phase difference, and the amplitude difference to obtain a short-range leakage cancellation channel coefficient; and performing a convolution on the FMCW signal and the short-range leakage cancellation channel coefficient to reconstruct the short-range leakage signal. In some embodiments, the short-range leakage cancellation method further includes performing an upsampling and a DFIR filtering on the FMCW signal. In some embodiments, the FMCW signal is a chirp signal with a linear modulation frequency. In some embodiments, a bandwidth of the RF signal is in a Wi-Fi frequency band.

It will be apparent to those skilled in the art that various modifications and variations can be made to the structure of the disclosure without departing from the scope or spirit of the disclosure cover modifications and variations of this disclosure provided they fall within the scope of the following claims.

What is claimed is:

1. A radar device, comprising:
a frequency modulated continuous wave (FMCW) generator configured to generate an FMCW signal;
a radio frequency (RF) circuit configured to modulate the FMCW signal into an RF signal and demodulate a reflection signal reflected at a target from the RF signal to obtain a received signal;
a computing circuit configured to reconstruct a short-range leakage signal according to the FMCW signal and an estimated channel coefficient, a delay coefficient, a phase coefficient, and an amplitude coefficient obtained in a short-range leakage estimation stage of the radar device; and
a coherent subtractor configured to compensate the received signal by the short-range leakage signal.

2. The radar device of claim 1, wherein the FMCW generator is further configured to generate a training sequence at the short-range leakage estimation stage, and wherein the computing circuit is further configured to perform a signal processing on a received training signal corresponding to the training sequence to obtain the estimated channel coefficient.

3. The radar device of claim 2, wherein the signal processing performed by the computing circuit further comprises the following operations:
clipping the received training signal to obtain a sequence signal;
combining a plurality of sample values of the sequence signal to obtain a received symbol;
performing a fast Fourier transform (FFT) on the received symbol to transform the received symbol into a frequency-domain received symbol;
removing an out-of-band component of the frequency-domain received symbol;
performing a point division on the frequency-domain received symbol and a frequency-domain chirp symbol to obtain a frequency-domain estimated channel coefficient; and
performing an inverse fast Fourier transform (IFFT) on the frequency-domain estimated channel coefficient, so as to transform the frequency-domain estimated channel coefficient into the estimated channel coefficient.

4. The radar device of claim 3, wherein the signal processing performed by the computing circuit further comprises performing a direct current (DC) compensation on the frequency-domain estimated channel coefficient.

5. The radar device of claim 3, wherein the signal processing performed by the computing circuit further comprises determining whether the estimated channel coefficient is valid based on a channel coefficient threshold.

6. The radar device of claim 2, wherein the training sequence comprises a chirp symbol and a cyclic prefix sequence prior to the chirp symbol, and wherein the cyclic prefix sequence is obtained by replicating a last plurality of sample values of the chirp signal.

7. The radar device of claim 1, wherein the short-range leakage signal is reconstructed by the computing circuit that performs the following operations:
calculating a delay difference, a phase difference, and an amplitude difference between a short-range leakage cancellation stage and the short-range leakage estimation stage corresponding to generation of the FMCW signal based on the delay coefficient, the phase coefficient, and the amplitude coefficient;
providing the delay difference to the FMCW generator for generating the FMCW signal accordingly;
computing the estimated channel coefficient, the phase difference, and the amplitude difference to obtain a short-range leakage cancellation channel coefficient; and
performing a convolution on the FMCW signal and the short-range leakage cancellation channel coefficient to reconstruct the short-range leakage signal.

8. The radar device of claim 1, further comprising:
an anti-imaging filter configured to perform an upsampling and a discrete finite impulse response (DFIR) filtering on the FMCW signal.

9. The radar device of claim 1, wherein the FMCW signal is a chirp signal with a linear modulation frequency.

10. The radar device of claim 1, wherein a bandwidth of the RF signal is in a Wi-Fi frequency band.

11. A short-range leakage cancellation method performed by a radar device and comprising:
generating an FMCW signal;
modulating the FMCW signal into an RF signal;
demodulating a reflection signal reflected at a target from the RF signal to obtain a received signal;
reconstruct a short-range leakage signal according to the FMCW signal and an estimated channel coefficient, a delay coefficient, a phase coefficient, and an amplitude coefficient obtained in a short-range leakage estimation stage of the radar device; and
compensating the received signal by the short-range leakage signal.

12. The short-range leakage cancellation method of claim 11, further comprising:
generating a training sequence at the short-range leakage estimation stage; and
performing a signal processing on a received training signal corresponding to the training sequence to obtain the estimated channel coefficient.

13. The short-range leakage cancellation method of claim 12, wherein the signal processing comprises the following operations:
clipping the received training signal to obtain a sequence signal;
combining a plurality of sample values of the sequence signal to obtain a received symbol;
performing an FFT on the received symbol to transform the received symbol into a frequency-domain received symbol;
removing an out-of-band component of the frequency-domain received symbol;
performing a point division on the frequency-domain received symbol and a frequency-domain chirp symbol to obtain a frequency-domain estimated channel coefficient; and
performing an IFFT on the frequency-domain estimated channel coefficient, so as to transform the frequency-domain estimated channel coefficient into the estimated channel coefficient.

14. The short-range leakage cancellation method of claim 13, wherein the signal processing further comprises performing a DC compensation on the frequency-domain estimated channel coefficient.

15. The short-range leakage cancellation method of claim 13, wherein the signal processing further comprises determining whether the estimated channel coefficient is valid based on a channel coefficient threshold.

16. The short-range leakage cancellation method of claim 12, wherein the training sequence comprises a chirp symbol and a cyclic prefix sequence prior to the chirp symbol, and wherein the cyclic prefix sequence is obtained by replicating a last plurality of sample values of the chirp signal.

17. The short-range leakage cancellation method of claim 11, wherein the short-range leakage signal is reconstructed by the following operations:
calculating a delay difference, a phase difference, and an amplitude difference between a short-range leakage cancellation stage and the short-range leakage estimation stage corresponding to generation of the FMCW signal based on the delay coefficient, the phase coefficient, and the amplitude coefficient;
generating the FMCW signal according to the delay difference;
computing the estimated channel coefficient, the phase difference, and the amplitude difference to obtain a short-range leakage cancellation channel coefficient; and
performing a convolution on the FMCW signal and the short-range leakage cancellation channel coefficient to reconstruct the short-range leakage signal.

18. The short-range leakage cancellation method of claim 11, further comprising:
performing an upsampling and a DFIR filtering on the FMCW signal.

19. The short-range leakage cancellation method of claim 11, wherein the FMCW signal is a chirp signal with a linear modulation frequency.

20. The short-range leakage cancellation method of claim 11, wherein a bandwidth of the RF signal is in a Wi-Fi frequency band.
